(19) United States
(12) Patent Application Publication
(10) Pub. No.: US 2011/0137483 A1
(43) Pub. Date: Jun. 9, 2011

(54) Method of real time remote control of transmission capacity of aerial power lines

(76) Inventors: Alastar Jenkins, Etobicoke (CA); Boris Mekhanoshin, Moscow (RU); Konstantin Mekhanoshin, Moscow (RU); Vladimir Shkaptsov, Moscow (RU)

(21) Appl. No.: 12/592,875

(22) Filed: Dec. 3, 2009

(51) Int. Cl. G06F 1/28

(52) U.S. Cl. 700/293

(57) ABSTRACT

A method of remote control of a transmission capacity of an aerial power line in real time including arranging on a cable of the power line devices monitoring parameters that characterize a condition of the cable including a cable temperature Tₖᵢ in a cross-section along a length of the cable, and a value of a current I in the cable in a time point t, determined in accordance with data of a GPS system received by the devices arranged on the cable, transmitting the data about the condition of the cable by the monitoring devices via channels GSM/GPRS to a receiving device of a concentrator arranged in a point of control of a mode of operation of the aerial line, from N values of Tₖᵢ selecting a maximum value Tₖₘₐₓ, and comparing the selected value with the value Tₖₗᵢₘ which is a maximum permissible cable temperature; and making a conclusion to reduce, to increase or to maintain a load current in the cable depending on a rating between Tₖₘₐₓ and Tₖᵢₗₘ.

### BACKGROUND OF THE INVENTION

The present invention relates to a remote control (monitoring) of power facility objects that can be used to obtain in real time data about a capacity of aerial power transmission lines to transmit electrical energy and power in a mode which corresponds to a maximum permissible mode, in real time, corresponding to a maximum permissible in real time current, which is determined in regard to actual conditions of use with consideration of influence of meteorological factors which are characteristic for the current time point.

The data obtained in real time can be used for providing information about a conductor temperature, an actual (measured) value of current transmitted through the line, and a maximum permissible current in a given moment, whose parameters can be displayed on devices in a control point for operation of aerial lines (for example on devices in a dispatch point). They can be also used directly in the systems of dispatch control (including automated control systems) for controlling a mode operation of an individual current transmission based on given algorithms and criteria and also in a network of the aerial lines as a whole.

The parameters of conditions of aerial lines in accordance with the invention can include for example a line temperature measured in one or several cross-sections along the line (in one of which a cable supposedly is subjected to the maximum heating in condition of most probable combinations of meteorological and operational influences), a load current, parameters (coordinates X, Y, Z) which determine with a certain accuracy of position of the line in space including its distance (clearance) to the ground, and also an air temperature whose values can be determined directly near the cables of the aerial line by a measuring device located directly near the place of a dispatch point or from other available sources (for example in accordance with the data of meteorological services), they are converted into a digital format and supplied to devices for accumulation and processing of control parameters, for example, in a concentrator of data, obtained from or several optional devices, a personal computer, or a server.

The results of the proposed method of remote control (monitoring) of transmission capacity in a real time can be used in order to increase efficiency of an operation control of individual aerial line or a network of electrical transmission lines provided with the system of monitoring, and are proposed for ensuring of reliable and safe operation of an aerial line/network of aerial lines in conditions of the maximum permissible utilization of their loading capacity.

Facilities which have electrical networks and dispatch control facilities use methods for controlling transmission capacity of aerial lines, based on utilization of fixed results of calculation of maximum permissible load currents, which are determined for a limited set of meteorological conditions, for example for 5-6 values of air temperature Ta and, correspondingly, 4-8 values of a wind speed V. In some cases the above mentioned meteorological factors, which are used in calculations, are supplemented by several values of intensity of solar radiation Q and a humidity level of air H. The method of control resides in that the dispatch service, with consideration of the above mentioned limited set of combinations of meteorological factors, tries to limit load current by preliminarily calculated fixed values of maximum permissible levels of current:

I=Imax=F(Tₐ,V,Q,H).

More efficient methods for controlling the operation of aerial lines are known, based on the use of the devices [1] and [2] for controlling the parameters of the cable of aerial lines, which have various means for data transmission in order to carry out monitoring in a real life.

The first method is based on the use of the device [1], which is mounted on a support of the areal line and configured as a sensor of tension of the cable (mechanical load transmitted to a tension set of insulators), provided with means for preliminarily processing, storage and transmission of data about measuring results, which allows to carry out monitoring of tension of cables of aerial lines in real line. Based on the data of tension values measured by the device [1], due to the use of additional information of meteorological nature, it is possible to compute a set of required parameters of cable condition and correspondingly a mode of operation of the aerial line.

This method and device [1] does not have a sufficiently high accuracy of the data about the cable condition, determined as a result of the additional analysis. The reason is that some important parameters, (one of which is a cable temperature) which characterize the condition of the cable and the aerial line as a whole, is determined not as a result of direct and straight measurement (such as for example temperature and position of a cable), but as a result of analysis of indirect data.

The temperature of the cable is determined in an indirect manner as a result of calculations with the use of the data about the value of cable pulling, temperature of environment, wind speed and current load of the cable at a moment of measurements. The position of the cable and its clearance from the ground also can be determined only indirectly—with the use of data of preliminary measurements of the position of the cable in calculated conditions, formulas and dependencies that characterize a connection of the value of the controlling cable tension with a clearance. Thereby the use of this method and device [1] does not allow to determine transmission capacity of aerial lines with a required accuracy.

A method of monitoring of cable condition is also know, based on the use of a device for remote control of meteorological parameters [2] arranged on a cable, which has a housing provided with means for mounting on the cable of a power line, with measuring sensors inside and outside. The sensors include a sun radiation sensor, a wind speed sensor, a winding discharge sensor, an environmental temperature control sensor, moisture and dew point control sensor, a precipitation registration sensor, a cable icing sensor, an acoustic crown sensor, a vibration measuring sensor. The device [5] is mounted on the cable and operates as an autonomous element of a system for monitoring of exterior actions.

The disadvantage of this method and device [2] is that the set of sensors and measuring units to be installed inside and outside of the device, obviously can not perform measurements without significant errors, due to influences of intense electrical and magnetic fields of the power line, action of corona discharges, the carrying of the device, and action of other possible interferences.

### SUMMARY OF THE INVENTION

It is therefore an object of the present invention to provide a possibility of operational fast (in real time) control of maximum permissible transmission capacity of an operating aerial line and, if necessary, to maintain reliable and safe operation of the aerial line with the maximum permissible of current of load in a system of direct immediate and automated control of a technological process.

In keeping with these objects and with others which will become apparent hereinafter, one feature resides, briefly stated, in a method for remote control of transmission capacity of aerial line of electrical transmission, based on the use of data obtained from a device for monitoring of condition of a cable of an aerial line disclosed in [3,4, 5] which is incorporated here by reference thereto and is patented in Russian Federation, in European community and in the United States. The use of this device allows in real time to obtain data about current I transmitted through the cable of an aerial line, a cable temperature Tₖ and a position of the cable (data of X, Y, Z coordinates of the cable in the places of location of the device), and data of time t of carrying out of measurements of the above mentioned parameters, annotating the above mentioned data of measurements with a high accuracy determined by characteristics of a GPS system [6], whose signals are received by the monitoring device [3, 4, 5]. The data of the air temperature Tₐ in a moment of obtaining data about the condition of the cable can be received from the monitoring device [3, 4, 5,], from an independent sensor of air temperature, or via one of channels of transmission of information of a state or corporate meteorological service. In addition to the above listed data of measurements, it is necessary to provide a set of parameters which characterize the cable used in the aerial line: values of coefficient of temperature elongation and maximum permissible cable temperature Tₘₐₓ. This value can be determined by an acting standard of a corporation, determined based on an analysis of physical characteristics of the cable arranged on the investigated aerial line—a temperature at which so-called Knee point is reached, or provided as a result of measurements of real sizes and calculations of “critical” temperature of the cable, at which in one or several “critical” spans of the aerial line distortions of a minimal permissible distance of the cable to the ground, to the crossing objects (for example in aerial line of lower voltage), or to the elements of trees-bushes, occur.

In accordance with a further embodiment of the invention, in addition to one or several devices which operate in accordance with the patents [4, 5, 6] and arranged directly on the cable of an aerial line on a span or spans of the line where based on meteorological or orographic data is expected to have a maximum heating of the cable, also some appliances are used which are provided on the control point of operation of the aerial line (for example in a dispatch point). Such appliances include a concentrator of data obtained from the devices arranged on the cable of the aerial line, a personal computer or a server, provided with means for reception of standard signals of a system of cellular telephony, directed by the devices which are arranged on the cable of the aerial line, and also from the sensor of the air temperature, or a means for obtaining data about temperature of environment from corporate or state structures of a meteorological service. The data about the cable temperature Tₖᵢ where i=1, 2, 3 . . . N, wherein N is a number of devices arranged on the aerial line, are received by the concentrator and compared there between with the select a maximum measured value of the cable temperature Tₖₖₘₐₓ. A personal computer is provided with a program for processing of obtained data and with a module containing information about characteristics of the cables used on the investigated objects, which may be arranged on one or several aerial lines (aerial line network) which is the object for utilization of the proposed method.

The information about characteristics of the cable must contain a set of data which are necessary for calculations of its heating temperature, for example:

W—specific weight of the cable, kg/(m*mm²)

E—modules of elasticity kg/mm²

T-_{koef}—temperature coefficient, 1/C

S_{q}—cross-sectional area of the cable, mm²

Np—tearing off force, kN ACSR type-type of the cable

D—exterior diameter of the cable (mm)

d—diameter of a core, mm

R—resistance of the cable to direct current at +20 C, mkOm/m

R1—thermal coefficient of resistance 1/deg

d1—diameter of wires of external layer of cable, m

N—number of cables in a bundle phase.

The data from one or several devices through the concentrator, the server, or directly through the receiving device are supplied in digital format corresponding to a standard protocol to the personal computer, where, in accordance with the preliminarily installed processing program, a calculation of cable temperature is carried out based on the use of the known method SIGRE [7] or IEEE [8]. During the carrying out of these calculations some arbitrary values of a wind speed V₀ and intensity of solar radiation Q are introduced, which are varied-wind speed V within a range of 0-10 m/s, solar radiation within intensity Q within a range of 0-3000 W/m². The varying of the above mentioned values is performed until the calculated value of the cable temperature Tₖₖ reaches with a sufficient accuracy to the value Tₖₖₘₐₓ—the maximum temperature measured by the devices [3, 4, 5,] which are arranged on the cable of the aerial line. The wind speed V determined by this way is used for an additional calculation of the value of current Iₖₘₐₓ, at which the cable temperature is Tₘₐₓ—or in other words the value of current which leads under known meteorological conditions to a maximum permissible value of the cable temperature of the investigated aerial line. The value Iₖₘₐₓ determined in this way characterizes the transmission capacity of the aerial line in a real moment of time.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an operational block-diagram of a device which is used for a method in accordance with the present invention;

FIG. 2 is a general view of appliances which are provided in a dispatch point for receiving and processing of the data transmitted by the device; and

FIG. 3 is a view showing the general view of the device [3, 4, 5] which is arranged on a cable of an aerial line.

### DESCRIPTION OF THE PREFERRED EMBODIMENTS

The device shown in FIG. 1 includes a power supply block 1, a control block 2, a block for obtaining and processing of signals of a cable condition of an aerial line 3; a block or preliminary processing of the obtained information, accumulation and storage of data 4, a block of communication and transmission of data 5. The cable of an aerial line is identified as 6.

The block 1 can be configured as an accumulator or current transformer and provided with means for charging from a current in the cable of the line and/or from a solar battery, which in this case is included in the device and not shown in the drawing.

The block 2 controls the operation of the blocks 3, 4, and 5 and of the device as a whole.

The block 3 includes a sensor of current parameters in the cable 6 identified with reference numeral 7, a sensor of temperature of the cable 6 identified with reference numeral 8, and a receiver of signals of a GPS with determination of its position in three-dimensional coordinate system (GPS receiver) 9.

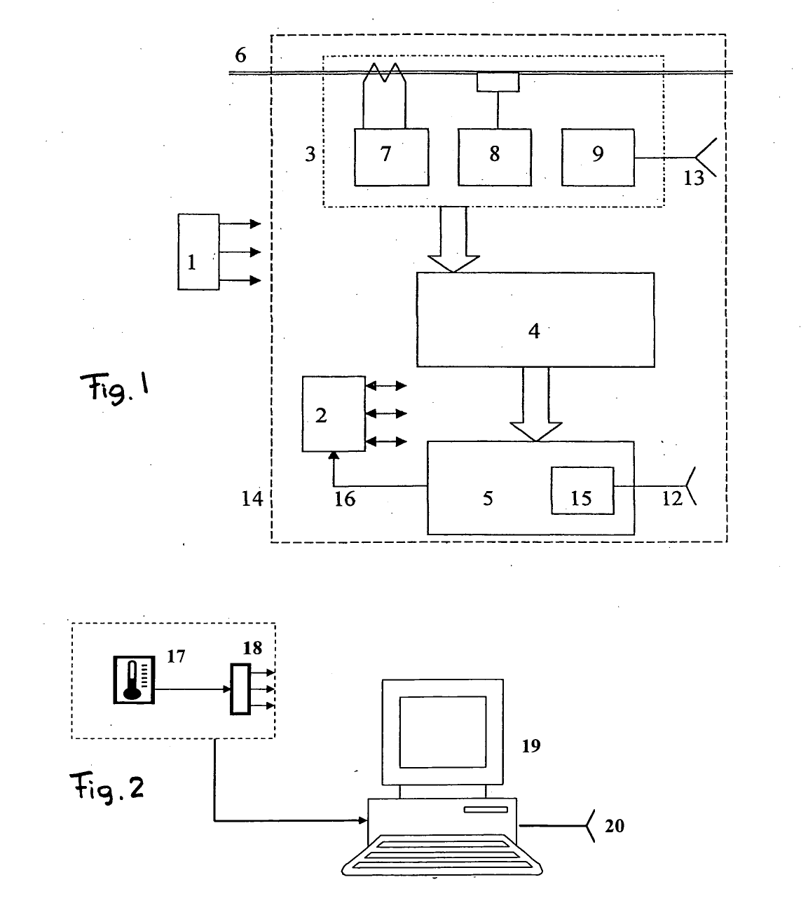

FIG. 2 shows a sensor of air temperature 17 or a means for obtaining in a digital format of data about an air temperature in real time from meteorological services (corporate or state), a data concentrator 18 connected with the air temperature sensor and also with the means for obtaining data (not shown in FIG. 2) from one or several devices [1, 2, 3] incorporated here by reference thereto arranged on the cable 6, and also a personal computer 19 located similarly to the concentrator in the dispatch point. It is provided with a preliminarily installed software, which includes a specialized program for calculation of a maximum permissible current Iₖₘₐₓ, which characterizes the transmission capacity of the aerial line. It is also possible in the event of arrangement of a single device on a separate aerial line and absence of a concentrator, to connect the computer directly to a system 20 for obtaining information via channels of GSM/GPRS from the device arranged on the aerial line.

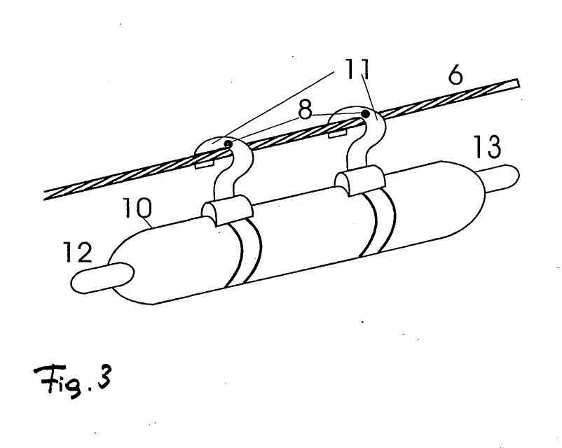

FIG. 3 shows a Houston 10 of the device arranged on the cable 6, a means 11 for mounting the housing 10 on the cable 6, antennas 12 and 13 of the block 5 and the receiver 9 of GPS signals, with the cable 6 and the sensor 8 incorporated in the means 11 or to other part of device but surely in direct contact with cable. The sensor 7 is not shown in FIG. 3 and the sensor 8 is composed of two parts or more.

The block 4 is connected with an output of the block 3 and an input of the block 5 and performs the functions of preliminary processing of the obtained information, accumulation and storage of data.

The block 5 provides a communication and transmission of data to a point of collection of measurement information.

The blocks 2, 4 and 5 can be formed as microprocessors with a software and structurally joined with the block 3 in a single measuring-transmitting module 14.

The means 15 of connection with a cellular telephone of a general use provided in the module 14 is shown in FIG. 1 inside the block 5. The block 5 can be provided also with means of reception of signals of requesting information, setting digital data, and protection on an unauthorized access, which are not shown in FIG. 1.

The sensor 7 operates as a current transformer and its construction can be carried out for example as current terminals.

The sensor 8 can be based one or two or more thermocouples which are built in the means 11 or to other parts of device but closely in direct contact with cable 6 for mounting of the housing 10 on the wire 6 (FIG. 3).

The receiver 9 provided in the module 14 is shown in FIG. 1 in the block 3. The receiver 9 can be based on a mass produced microcircuit of the GPS receiver.

The antennas 12 and 13 are connected to the block 5 and the receiver 9 correspondingly and provide their operation.

The device [1, 2, 3] or several devices are arranged directly on the cable of the aerial line in one or several spans of the line and operate in the following manner.

By means of the sensor 8, the block 3 receives an analog electrical signal which corresponds to the temperature of the cable 6, converts it into digital data, and transmits it to the block 4 where they are stored, accumulated and preliminarily processed.

By means of the sensor 7 the block 3 obtains an analog electrical signal corresponding to the current in the line (and carrying the information about the current value, frequency, phase, etc.), converts it into digital data and transmits to the block 4, where they are stored, accumulated and preliminarily processed.

The block 3 by means of the receiver 9 receives signals from the GPS satellites [7]. The receiver 9 is provided with an analyzer of signals of the GPS, which, in accordance with the relative delays, determines (approximately once in a microsecond) the position of the receiver and a three-dimensional coordinate system. The data about coordinates of the receiver 9 (and, correspondingly, of the cable 6) are supplied from the block 3 into the block 4, where they, together with other parameters, are stored, accumulated and preliminarily processed. During this process a certain increase of resolution of the receiver is obtained, which allows to measure a relatively small displacements of the cable of the aerial line with the use of GPS, preliminarily provided for the determination of mobile objects. This effect is connected with the fact that before generation of intense oscillations of the cable the receiver of GPS signals for a long time receives them, being practically in a stationary condition.

The data is supplied from the block 4 to the block 5 which provides a transmission to the point of accumulation of information about condition (temperature, current and spatial position) of the cable.

In the case of realization of the invention when the module 14 is provided with the means 15 (modem), the transmission of data is performed via channels of cellular or satellite telephones, provided for common use. The data transmission can be carried out periodically with an interval, for example of 15 minutes, or in accordance with the inquiry from the point of collection of processing of information. In the last case the block 5 must be provided with means and receiving signals of inquiry of information and can be connected with the block 2 by circuit 16 which initiates the operation of the device.

In the point of collection and processing of information, the reception of data and transmission of control signals (inquiries for transmission and set data) is performed by a specialized device—a concentrator, or with the use of a personal computer, whose connection with a communication channel can be carried through a cellular or satellite telephone, for example by means of a standard modem.

The proposed device utilizes a known means of common use (signals of GPS system and telephone channels of cellular connection) for the specific control of parameters of a condition of the cable of power line of electrical transmission.

The cellular or satellite communication is used not for its direct purpose (telephone connection of mobile users) but for providing a technological telephonic connection with an object under a high voltage. The technical result from the use of a cellular or satellite connection in the present invention is that it is not necessary to create and use a means for high voltage connection, and a specialized technological communication system. The reliability of autonomous operation of the device is also increased, since the operation of the telephonic circuit for communication of common use (including cellular or satellite communication) as a rule is maintained when several lines, power substations, electric power stations and even energy systems fail there are breaks in their operation.

It should be mentioned that the use of mobile telephone communication in the system of remote control of the operation of electrical household devices disclosed in [10] does not provide transmission of the data directly from the elements (sensors) arranged on the current conductive (an especially on high-voltage) components of the equipment and therefore does not provide for the highly advantageous results which are obtained from the present invention. In [10] a different task is solved and different technical result is achieved, in particular the use of a mobile phone which is ready mobile and in possession of a user as a remote terminal of the system, based on the property of the mobile phones such as the presence of a display suitable for displaying control instructions and results of the control of the electrical household devices.

The proposed method of remote control of the transmission capacity of an aerial line of electrical transmission in real time, based on the use of the devices [1, 2, 3] operates in the following manner.

The concentrator 18 receives data from one or more devices [1, 2, 3] arranged on the cable of the aerial line. The data about a cable temperature Tₖᵢ where I=1, 2, 3 . . . N and N is a number of the devices arranged on the cable of the aerial line, obtained by the concentrator are compared with one another for the purpose of selection of a maximum measured value of the cable temperature Tₖₖₘₐₓ, The concentrator obtains also the data about air temperature Tₐ from the device 17. From the concentrator all above mentioned data are supplied to a personal computer provided with a software for their processing and calculation of a maximum permissible current Iₖₘₐₓ, which characterizes the transmission capacity of the aerial line in a real time mode. The thus calculated maximum permissible current is determined with the consideration of the meteorological factors of a real moment of time, since these factors influence the temperature of the cable, determined by the devices [1, 2, 3] arranged on it with the consideration of physical properties of the cable 6 (introduced into the personal computer) and finally with the consideration of the value Tₘₐₓ established by standards or calculated value of the maximum permissible temperature of heating of the cable, or in other words the temperature at which no degradation of the cable takes place and the distances (clearances) from the cable from the ground and corresponding objects set by the standards are not violated.

### INDUSTRIAL APPLICABILITY

The application of the method in accordance with the present invention requires satisfaction of at least one of two requirements to the place of arrangement of the device on the aerial line:
it must be located in a zone of covering by at least one system of mobile telephone communication;
it must be accessible for simultaneous reception of signals of at least three satellites of GPS group, whose number includes about 21 orbital objects.

At present the first requirement is satisfied in developed regions with a high density of population, while the second requirement due to the great number of orbital objects of GPS group uniformly located on the orbit around the earth is satisfied practically at any point of the earth surface.

It will be understood that each of the elements described above, or two or more together, may also find a useful application in other types of methods differing from the type described above.

While the invention has been illustrated and described as embodied in method of remote control of transmission of capacity of aerial power lines in real life, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

### SOURCE OF INFORMATION

1. T. Seppa, et al. Use of on-line tension monitoring for real-time thermal rating, ice loads, and other environmental effects. CIGRE session 1998, report 22-102.
2. R. A. Fernandes. High voltage conductor mounted line powered system. U.S. Pat. No. 5,029,101. Date of patent Jul. 2, 1991.
3. RU 2,222,858 Device for Remote Control of Conditions of a Cable of Aerial Line of Electric Transmission.
4. European patent no. 1574822. Device for Telemonitoring the State of Aerial Power Lines (var.).
5. U.S. Pat. No. 7,430,932 Device for Telemonitoring the State of Aerial Power Lines (VAR).
6. Understanding GPS: Principles and applications. Edition Elliot D. Kaplan, Arteeh Hon., Boston, London, 1996.
7. CIGRE WG 12.12 “The Termal Behavior of Overhead Conductor Section 1 & 2: Mathematical Model for Evaluation of Conductor Temperature in the Steady State and Application Thereof, Electra 144, pp 107-1025, October 1992.
8 IEEE Standard, for Calculating the Current-Temperature of Bare Overhead Conductors, IEEE Std 738^{TH}-2006.
9. PCT Application Publication WO 01/28068, 2001. System for Monitoring and Controlling of Set of Household Appliances.

1. A method of remote control of a transmission capacity of an aerial electric power line in real time, comprising the steps of arranging on a cable of the power line from 1 to N devices located in different spans along the aerial line for monitoring parameters that characterize a condition of the cable including a cable temperature Tₖᵢ where i=1, 2 . . . N correspondingly in N cross-section along a length of the cable, and a value of a current I in the cable in a time point t, determined in accordance with data of a GPS system received by the devices arranged on the cable; transmitting data about the condition of the cable by the monitoring devices arranged on the cable via channels GSM/GPRS to a receiving device of a concentrator arranged in a point of control of a mode of operation of the aerial line; providing in the concentrator a communication channel with a personal computer having programs for processing the data; from N values of Tₖᵢ selecting in accordance with the program a maximum value Tₖₘₐₓ, and comparing the selected value with a value Tₖₗᵢₘ which is a maximum permissible cable temperature; making a conclusion that when Tₖₘₐₓ=Tₖₗᵢₘ then the current in the cable I=Iₘₐₓ determines in real time point a transmission capacity of the aerial line, when Tₖₘₐₓ>Tₖₗᵢₘ then the current I exceeds the transmission capacity of the aerial line and a load current is to be reduced to a level at which the temperature of the cable satisfies a condition Tₖₘₐₓ=Tₖₗᵢₘ, and when Tₖₘₐₓ<Tₖₘᵢₙ then a current is lower than the transmission capacity of the aerial line and the load can be increased to a level I=Iₘₐₓ for obtaining a balance controlled by the monitoring devices arranged on the cable and determined by Tₖₘₐₓ=Tₖₗᵢₘ; performing the determining of the condition of the cable by the monitoring devices arranged on the cable and transmitting corresponding data to the point for controlling the operation of the aerial line with predetermined intervals ti; evaluating the balance in accordance with the cable Tₖₘₐₓ=Tₖₗᵢₘ of the same intervals; and controlling and displaying on devices for visualization data about the current value of the load current I and a possibility of increase of current under the condition when Tₖₘₐₓ<Tₖₗᵢₘ until transmission capacity is obtained characterized by the balance Tₖₘₐₓ=Tₖₗᵢₘ or about a necessity to reduce the load under the condition Tₖₘₐₓ>Tₖₗᵢₘ to a level corresponding to the transmission capacity of the aerial line in real moment of time under actual meteorological and operational conditions.

2. A method as defined in claim 1; further comprising obtaining data about an air temperature tₐ in a moment of time t in a manner selected from the group consisting of obtaining the data about the air temperature from one or several sensors arranged on the cable and from corporate or state meteorological services; and transmitting the data about the air temperature to a device selected from the group consisting of the concentrator and the personal computer.

3. A method as defined in claim 2; further comprising introducing into the personal computer data characterizing physical and geometrical parameters of the cable, and with the use of the data received from monitoring devices, the data about air temperature, and data about the current in the cable, calculating a cable temperature Tₖ, under a presumption that a value of intensity of solar radiation Q and a value of a speed of wind V is equal zero.

4. A method as defined in claim 3; further comprising comparing the thusly calculated value of cable temperature Tₖₒ with the value Tₖₘₐₓ obtained from the monitoring; when Tₖₒ<Tₘₐₓ increasing the value of wind speed Vⱼ to a value 10 M/s with a minimal step, for each subsequent value Vⱼ calculating the cable temperature Tₖⱼ, repeating calculations until a relationship Tₖⱼ<Tₖₘₐₓ after “Tₖₘₐₓ” insert is obtained; when Tₖⱼ;=Tₖₘₐₓ−1 a corresponding value of Vⱼ is fixed as V_{f} and the calculation is stopped.

5. A method as defined in claim 4; further comprising continuing the calculations of the cable temperature with the use of a value of wind speed V_{f} for values of intensity of solar radiation Q changing from zero to 1000 W/m² with a minimal step, and determining a value Qf with which Tₖⱼ=TKₘₐₓ35 0.01, continuing the calculations of the cable temperature for the determined values V_{f} and Q_{f}, with successive increase of the current value Iⱼ from the value I determined by the monitoring device with a minimum step, continuing the determining values of parameters V_{f} and Q_{f} with the step 10A of the current parameter Iⱼ until value Tₖⱼ is found at which Tₖⱼ=Tₗᵢₘ±1, such that the current value I=I_{f} at which the ratio Tₖⱼ=Tₗᵢₘ±1 is satisfied, corresponds to acceptable approximation to a value of the transmission capacity of the aerial line in real time.

6. A method as defined in claim 5, and further comprising displaying a current value of the current I determined by the monitoring devices as well as a value of the calculations I_{f} on a monitor in a dispatch point and/or directly using the same in systems of automated control of a mode of operation of the power transmission in accordance with algorithms accepted on enterprises of electrical power networks or in a dispatch service.
